(19) United States
(12) Patent Application Publication
(10) Pub. No.: US 2011/0154821 A1
(43) Pub. Date: Jun. 30, 2011

(54) Estimating Pre-Turbine Exhaust Temperatures

(76) Inventor: LINCOLN EVANS-BEAUCHAMP, Palo Alto, CA (US)

(21) Appl. No.: 12/647,287

(22) Filed: Dec. 24, 2009

(51) Int. Cl. F02G 3/00; G01M 15/04; F03B 13/00

(52) U.S. Cl. 60/615; 73/114.69; 73/114.37; 290/52

(57) ABSTRACT

Methods are provided for estimating an exhaust temperature of an engine exhaust of a turbocharged engine prior to an inlet of the turbine of the turbocharger. These methods estimate the pre-turbine exhaust temperature based on thermodynamic equations and measured temperature and pressure values from elsewhere in the system. The estimated pre-turbine exhaust temperature can be used for controlling the engine, for verification of the emissions control system, and can also be compared against actual measurements of the pre-turbine exhaust temperature to evaluate engine performance. The present invention also provides turbocharged engine systems including sensors to make the required measurements and logic configured to estimate the pre-turbine exhaust temperature.

### BACKGROUND

1. Field of Invention

The present invention relates generally to turbocharged engines and more particularly to emission control systems for such engines.

2. Related Art

An operating diesel engine produces an exhaust that includes undesirable emissions such as particulates and nitrogen oxide compounds (NOₓ). Accordingly, these emissions are typically reduced through the use of emission control systems. Different jurisdictions have different rules that govern acceptable levels of emissions and various aspects of the certification and use of such emission control systems. The rules include an engine operating envelope within which the emission control system is deemed to be effective.

In California, the Air Resources Board (CARB) provides regulations that establish a verification procedure for diesel emission control systems (California Code of Regulations, Title 13, Division 3, Chapter 14, incorporated herein by reference). An emissions control system must successfully fulfill a verification procedure prior to its on-road use; a vehicle operating in the state with an emissions control system that has not passed verification is subject to confiscation. One of the requirements of the verification procedure is that the applicant has to measure and record exhaust temperatures, typically the operating temperature of the emissions control system of diesel engines at intervals over some period of time for both engines with and without the emission control system. This temperature data may be used to establish parameters for the engine operating envelope.

Sensors capable of accurately and reliably making measurements while subject to the high temperature, pressure, and vibrations of an exhaust gas environment are not cost-effective. Measuring the exhaust temperature for a diesel engine equipped with a turbocharger requires measuring the exhaust temperature between the diesel engine and the turbine of the turbocharger to provide an accurate measurement. This adds extra complexity to the task of configuring an engine to provide the necessary data to satisfy the verification procedure for an emission control system.

In some jurisdictions, the engine must be operated within the engine operating envelope that has been established for the emissions control system. Various engine parameters are monitored and recorded in real time to determine if the engine is within the engine operating envelope. An indicator may alert the operator when the engine is outside the envelope. The recorded data may be used by authorities to assess penalties or fees for operations outside of the engine operating envelope. The operating envelope is limited by the parameters that can be economically monitored.

### SUMMARY

An exemplary method of the invention comprises the steps of measuring a post-turbine exhaust temperature at an exhaust port of a turbine of a turbocharger, and measuring a first air pressure between an engine intake and a compressor of the turbocharger. The exemplary method further comprises estimating a pre-turbine exhaust temperature based upon the post-turbine exhaust temperature and the first pressure. In various embodiments, the method further comprises measuring an initial air temperature at an intake of the compressor, and/or measuring an initial air pressure at the intake of the compressor. In these embodiments, estimating the pre-turbine exhaust temperature further comprises estimating the pre-turbine exhaust temperature based additionally on the initial air temperature and/or pressure.

Further methods of the invention are directed to uses for the estimated pre-turbine temperature. For example, a method of regulating the engine can comprise estimating the pre-turbine temperature as provided above, and can further comprise altering an aspect of the operation of the engine based on the estimated pre-turbine temperature. As another example, the pre-turbine temperature can be used to evaluate how well the engine and/or turbocharger is operating. Methods according to these embodiments comprise estimating the pre-turbine temperature as provided above, and further comprise measuring the pre-turbine temperature and determining a difference between the measured pre-turbine temperature and the estimated pre-turbine temperature. Yet another example of a use is in a verification process for an emissions control system. Methods according to these embodiments comprise estimating the pre-turbine temperature as provided above and further comprise recording the estimated pre-turbine exhaust temperature. Records of the estimated pre-turbine exhaust temperature can be used to show compliance.

The present invention also provides systems comprising turbocharged engines. An exemplary system comprises an engine, such as a diesel engine, and a turbocharger in fluid communication with the engine. The turbocharger includes a compressor having a compressor intake and a compressor output and a turbine having a turbine intake and a turbine output. The exemplary system also comprises a turbine output temperature sensor disposed at the turbine output and pre-engine pressure sensor disposed between the compressor output and an engine intake of the engine. The exemplary system further comprises logic in communication with the turbine output temperature sensor and the pre-engine pressure sensor, and configured to estimate a pre-turbine exhaust temperature based upon the post-turbine exhaust temperature and the first pressure. In various embodiments the system comprises a vehicle, where the engine is configured to propel the vehicle or produce work (as in a pump), or the system comprises an electric generator, where the engine is configured to generate electricity.

In various embodiments of the system, the system also comprises an initial temperature sensor and/or an initial pressure sensor disposed at the compressor intake. Various embodiments may also comprise a pre-turbine temperature sensor disposed between the turbine intake and an exhaust port of the engine so the estimated pre-turbine temperature can be compared against an actual measurement. The logic of the system, in some embodiments, is further configured to alter an aspect of the operation of the engine based on the estimated pre-turbine temperature.

An exemplary method for extending an operating envelope of an engine in fluid communication with an emissions control system and a turbocharger including a compressor and a turbine comprises the steps of receiving at a computing system a first value representing an initial temperature from an initial temperature sensor disposed upstream of an intake of the compressor, a second value representing a compressor temperature from a pre-engine temperature sensor disposed between the compressor and the engine, and a third value representing a post-turbine exhaust temperature from a post-turbine sensor disposed downstream of an outlet of the turbine. The exemplary method further comprises estimating a pre-turbine exhaust temperature of exhaust gas between the engine and the turbine based upon the first value, the second value and the third value and determining if the engine is operating within the operating envelope for the engine and the emissions control system based on the estimated pre-turbine exhaust temperature. The exemplary method includes activating an indicator based on the determination.

Further methods of the invention are directed to uses for the estimated pre-turbine temperature. For example, a method of regulating the engine within the operating envelope of the emissions control system can comprise estimating the pre-turbine temperature as provided above, and can further comprise altering an aspect of the operation of the engine based on the estimated pre-turbine temperature. As another example, estimating and using the pre-turbine exhaust temperature is performed in real time. Methods according to these embodiments comprise estimating the pre-turbine temperature as provided above and further comprise recording the estimated pre-turbine exhaust temperature at intervals over a period of time. At least one of the intervals may include about one minute, two minutes, four minutes, eight minutes, fifteen minutes, thirty minutes, one hour, two hours, four hours, eight hours, twelve hours, one day, two days, one week, or one month. The period of time may include about one hour, two hours, four hours, eight hours, twelve hours, one day, two days, one week, one month, one year, or two years.

### BRIEF DESCRIPTION OF THE DRAWINGS

FIG. 1 is a schematic representation of an engine and turbocharger configured for estimating a pre-turbine exhaust temperature of the engine exhaust according to an exemplary embodiment of the present invention.

FIG. 2 is flowchart representation of a method for estimating the pre-turbine exhaust temperature of the engine exhaust according to an exemplary embodiment of the present invention.

FIG. 3 is a schematic representation of an engine and turbocharger configured for estimating a pre-turbine exhaust temperature of the engine exhaust according to another exemplary embodiment of the present invention.

FIG. 4 illustrates a system according to another exemplary embodiment of the present invention.

FIG. 5 is a diagram illustrating an engine operating envelope.

### DETAILED DESCRIPTION

The present disclosure is directed to methods for estimating an exhaust temperature of an engine exhaust of a turbocharged engine prior to an inlet of the turbine of the turbocharger. The present disclosure is also directed to methods for using the estimated values, for example, to evaluate the operation of the turbocharger or to regulate an emissions control system or an engine. The present disclosure is further directed to systems that are configured to estimate the pre-turbine exhaust temperature of the engine exhaust.

Exemplary methods for estimating the pre-turbine exhaust temperature comprise making temperature and/or pressure measurements at several other points in the engine/turbocharger system. These methods further comprise estimating the pre-turbine exhaust temperature by solving thermodynamic equations using as inputs these measurements as well as certain stored values, and in some instances by applying simplifying approximations. The estimated pre-turbine exhaust temperature can be used in an operating turbocharged engine to regulate an emissions control system for that engine. The estimated pre-turbine exhaust temperature can also be used to comply with an emissions control system verification procedure. The estimated pre-turbine exhaust temperature can also be compared to a measured pre-turbine exhaust temperature to evaluate the operation of the engine.

The estimated pre-turbine exhaust temperature can be used for qualifying an emissions control system for use on an engine. The engine may be operated without an emissions control system while an estimated pre-turbine exhaust temperature is collected to characterize an operating envelope for the engine. A combination of the engine and emissions control system may be operated while an additional estimated pre-turbine exhaust temperature is collected to characterize an operating envelope for the combination.

The disclosure also provides turbocharged engines configured with sensors and logic for performing one or more of the disclosed methods. The disclosure further provides sensors and logic that when attached to a turbocharged engine can perform one or more of the disclosed methods.

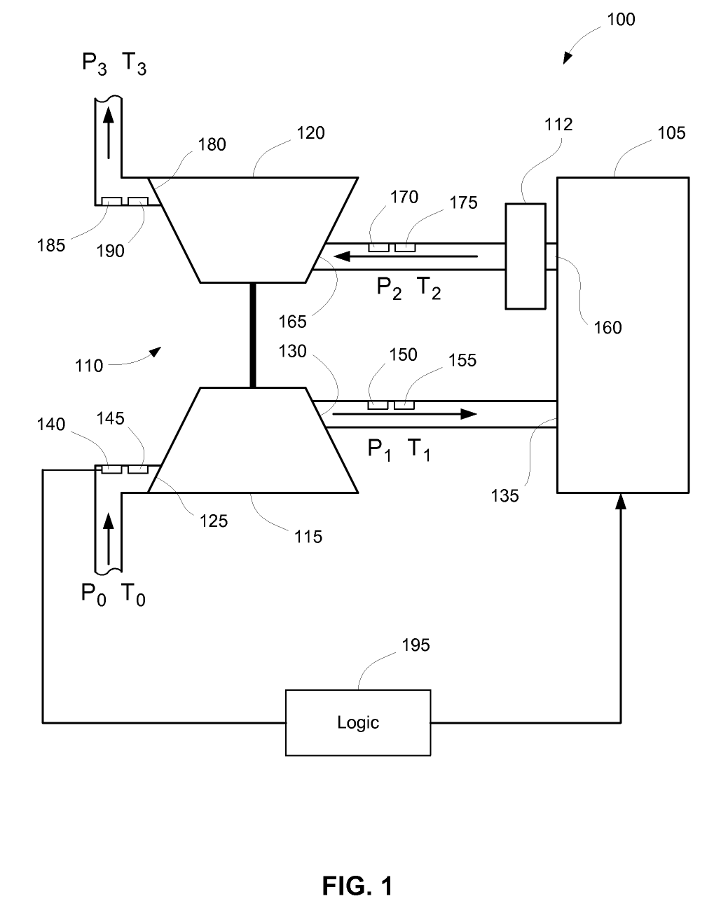

FIG. 1 illustrates a system 100 according to an exemplary embodiment of the present invention. The system 100 represents a system having a turbocharged internal combustion engine and emissions control system such as a vehicle or an electric power generator. The system 100 comprises an internal combustion engine 105 in fluid communication with a turbocharger 110 and an optional emissions control system 112. The turbocharger 110 comprises a compressor 115 and a turbine 120. Exemplary internal combustion engines 105 include gasoline, natural gas, hydrogen, and diesel fueled engines. Exemplary emissions control systems include catalytic converters, mufflers, particulate traps, particulate filters, selective catalytic reduction systems, seawater scrubbing systems, exhaust gas recycling systems, filter bags (power plants), particulate separators and/or the like. Exemplary emissions control systems further include combustion purifiers. See, e.g., U.S. patent application Ser. Nos. 11/404,424, 11/787,851, and 11/800,110 and U.S. Pat. Nos. 7,500,359 and 7,566,423 which are incorporated herein by reference. While the emissions control system 112 is illustrated as disposed between the engine 106 and the turbine 120, the emissions control system 112 may be disposed at the output of the turbine 120.

In operation, air with an initial temperature (T₀) and initial pressure (P₀) enters the turbocharger 110 through a compressor intake 125 to the compressor 115. The air is compressed by the compressor 115 allowing the engine 105 to burn more fuel and produce more power per cycle. The compressed air in the system 100 between a compressor output 130 of the compressor 115 and an engine intake 135 of the engine 105 is characterized by a pre-engine temperature (T₁) and pre-engine pressure (P₁).

It should be noted that in some embodiments the initial temperature and pressure will be ambient values of about 1 atmosphere (atm) and 25° C. In other embodiments these values may vary from ambient values due to components in the air intake system (not shown) that precedes the compressor 115 of the turbocharger 110. For example, the pressure drop across an air filter will cause the initial pressure to be sub-ambient.

The values for the initial temperature and pressure can be assumed constants, in some embodiments, while in other embodiments these values are continuously or periodically measured. For example, in some embodiments the system 100 comprises an initial temperature sensor 140 and/or an initial pressure sensor 145 disposed at the compressor intake 125. As used herein, a measurement device, such as a sensor, disposed “at” a location that is indicated by a structural component, such as disposed at the compressor intake 125, means that the measurement device is disposed within a duct, tube, manifold, conduit, or the like close enough to the structural component as to be able to obtain a reasonably representative measurement of a property of the air or the exhaust as it enters or exits the structural component. The pre-engine temperature and pre-engine pressure can likewise be measured by a pre-engine temperature sensor 150 and a pre-engine pressure sensor 155.

After fuel has been burned in the engine 105, the air, now deemed to be exhaust, leaves the engine through an engine exhaust manifold 160. The exhaust in the system 100 between the engine exhaust manifold 160 and a turbine intake 165 of the turbine 120 is characterized by a pre-turbine exhaust temperature (T₂) and pre-turbine exhaust pressure (P₂). Although methods are described herein for estimating pre-turbine exhaust temperature and/or pressure, additional methods disclosed herein compare such estimates against measured values, and accordingly some embodiments of the system 100 optionally comprise a pre-turbine temperature sensor 170 and/or a pre-turbine pressure sensor 175 disposed between the turbine intake 165 and the engine exhaust manifold 160.

The exhaust from the engine exhaust manifold 160 next enters the turbine 120 through the turbine intake 165, drives the turbine 120 to run the compressor 115, and exits the system 100 through a turbine outlet 180 with a post-turbine exhaust temperature (T₃) and post-turbine exhaust pressure (P₃). The post-turbine exhaust temperature and/or pressure can be measured, for example, with a post-turbine temperature sensor 185 and/or a post-turbine pressure sensor 190 disposed at the turbine outlet 180. The various sensors noted above can be components of the system 100, in some embodiments, while in other embodiments one or more of the sensors can be components of a testing system that is temporarily coupled to the system 100.

It will be appreciated that pressure and temperature values can be measured in many ways, for example, by employing absolute, relative, and/or differential sensors. For instance, P₁ can be measured directly with an absolute measurement; by a relative or gauge pressure sensor, assuming a 1 atm ambient pressure; or via a differential sensor that measures the pressure difference between P₁ and P₀.

System 100 also comprises logic 195. The logic 195 is in electrical communication with the various sensors of the system 100. For clarity, only the connection between the logic 195 and the initial temperature sensor 140 is shown while the other connections have been omitted. In a vehicle, the logic 195 can be in communication with an on-board computer (not shown) for the vehicle or can be integrated into the vehicle's on-board computer. Logic 195 can also be external to the system 100 in some embodiments. For example, the logic 195 can reside in an engine testing system that is configured to be detachably coupled to the system 100. In some embodiments, some of the sensors noted with respect to FIG. 1 are integral to the system 100 while other sensors are removable or replaceable.

As used herein, logic 195 is limited to electronic computing systems that can execute steps of the methods disclosed herein. Logic 195 can be implemented as hardware, for example, such as an application-specific integrated circuit (ASIC), with circuits specifically configured to perform the particular functions of a disclosed method. Logic 195 can also be implemented as firmware, defined herein as the combination of an electronic device with program instructions and optionally data that reside in a non-volatile memory on that device. An example of firmware includes, for instance, an EEPROM including program instructions, where the program instructions perform the particular functions of a disclosed method.

Logic 195 can also comprise a computing system including a microprocessor and a random access memory (RAM). Here, the microprocessor is configured to execute software residing in the random access memory, where the computer instructions embodied in the software perform steps of a disclosed method. Computer systems described herein can also comprise any combination of two or more of hardware, firmware, and software. For example, the computing system may include digital logic and analog circuits including analog logic. Accordingly, the computing systems described herein execute computerized processes by following logic embodied in circuits or programming instructions, or both, to perform the specific methods described herein, and therefore these computing systems constitute specific machines.

Although FIG. 1 shows a system 100 having a complete set of sensors to measure both temperature and pressure at each of the four locations noted, various embodiments of the present invention include less than the full set. For example, a system 100 configured to estimate pre-turbine exhaust temperature can include only post-turbine temperature sensor 185 and pre-engine pressure sensor 155. Improved estimates of the pre-turbine exhaust temperature can be obtained with additional sensors such as initial temperature sensor 140 and/or initial pressure sensor 145 and/or temperature and pressure sensors (not illustrated) between an intercooler (not illustrated) and the engine 105. The following equations and simplifying assumptions can be used by logic 195 to estimate pre-turbine exhaust temperature. It will be appreciated that the same equations and assumptions can be used to estimate temperature and pressure at other locations as well. Additional sensors of the ones described with respect to FIG. 1 can be used to improve the estimates. Moreover, combinations of sensors other than post-turbine temperature sensor 185 and pre-engine pressure sensor 155 can be used in conjunction with these equations and assumptions to estimate the pre-turbine exhaust temperature.

The present invention relies on thermodynamic equations for isentropic (constant entropy) operation of a turbocharger 110. Considering first the compressor 115, in the ideal circumstance where the compressor 115 operates at 100% efficiency, the ratio of the temperatures on either side of the compressor 115 is proportional to the ratio of the pressures on either side of the compressor 115 according to the equation:

$$\frac{{T}_{1 i}}{{T}_{0 i}} = {[ \frac{{P}_{1 i}}{{P}_{0 i}} ]}^{( 1 - \frac{1}{γ} )}$$

where the subscript ‘i’ denotes ideal circumstances and γ is the specific heat ratio for the fluid undergoing compression which equals the specific heat at constant pressure divided by the specific heat at constant volume for that fluid. For air, γ is approximately 1.4.

Another equation for the compressor 115 relates the actual (“real”) temperature T₁r to the ideal temperature T₁i according to the compressor efficiency, η_{c}:

$$( {T}_{1 r} - {T}_{0 r} ) = [ \frac{{T}_{1 i} - {T}_{0 i}}{{η}_{c}} ]$$

where the subscript ‘r’ denotes real or measured temperature and pressure. The compressor efficiency can be assumed to be a constant over all operating conditions, or for better estimation can be obtained from tabulated values.

Lastly, the work performed by the compressor 115, W_{c}, is a function of the temperature difference across the compressor, the heat capacity, C_{pc}, of the fluid in the compressor at constant pressure, and the mass flow rate through the compressor 115, \dot{M}_{c}, according to the following equation:

W_{c}=C_{pc}\dot{M}_{c}(T₁ᵣ−T₀ᵣ)

Here, C_{pc} is about 1.012 J/g° K for dry air at room temperature and 1 atm. \dot{M}_{c} will vary according to the operating conditions of the system 100. Another simplifying assumption, discussed below, makes it unnecessary to know the value of \dot{M}_{c}.

Considering next the turbine 120, the ratio of the ideal temperatures on either side of the turbine 120 is proportional to the ratio of the real pressures on either side of the turbine 120 according to the equation:

$$\frac{{T}_{3 i}}{{T}_{2 i}} = {[ \frac{{P}_{3 r}}{{P}_{2 r}} ]}^{( 1 - \frac{1}{γ} )}$$

and the real temperature difference across the turbine 120 is related to the ideal temperature difference across the turbine 120 by:

$$( {T}_{3 r} - {T}_{2 r} ) = [ \frac{{T}_{3 i} - {T}_{2 i}}{{η}_{t}} ]$$

Where ηₜ is the efficiency of the turbine 120. Similar to the above, the work performed by the turbine 120, Wₜ, is expressed by:

Wₜ=Cₚₜ\dot{M}ₜ(T₃ᵣ−T₂ᵣ)

Where \dot{M}ₜ is the mass flow rate through the turbine 120 and Cₚₜ is the heat capacity of the fluid in the turbine at constant pressure

Additionally, the work produced by the turbine is related to the work produced by the compressor in that the ratio of the compressor work to the turbine work is the mechanical efficiency η_{mech} of the mechanism linking the two. This can be expressed as:

W_{c}=η_{mech}Wₜ

Accordingly, the better the turbocharger efficiencies (turbine, compressor, mechanical) are established, the better the estimated value for the pre-turbine exhaust temperature will be, given appropriate readings sensor readings. For simplicity, the term η_{mech} may incorporate in various combinations efficiency of the turbine, the compressor, and/or mechanical linkage between the turbine and compressor.

A further simplifying assumption is that the mass flow rate, \dot{M}ₜ, through the turbine 120 equals the mass flow rate, \dot{M}_{c}, through the compressor 115. While the combustion products from the engine 105 do increase the turbine mass flow rate over the compressor mass flow rate, the difference can be ignored, in some instances. In other instances a proportionality constant can be employed to account for the increase. For example, the turbine mass flow rate can be assumed to be 15/14^{th} of the compressor mass flow rate. This ratio accounts for the stoichiometric ratio of the fuel to the air which is about 14 to 1 for a diesel engine. Hence, 14 pounds of air are required to burn 1 pound fuel, yielding 15 pounds of exhaust gasses. Also, the heat capacities of the incoming air at the compressor, C_{pc} and of the outgoing exhaust, Cₚₜ are different, but again, the difference is minor and another simplifying assumption is that these are also equal (C_{pc}=Cₚₜ). Without these assumptions:

W_{c}=C_{pc}\dot{M}_{c}(T₁ᵣ−T₀ᵣ)=η_{mech}Cₚₜ\dot{M}ₜ(T₃ᵣ−T₂ᵣ)

Applying the simplifying assumption that C_{pc}=Cₚₜ, this equation can be reduced to:

\dot{M}_{c}(T₁ᵣ−T₀ᵣ)=η_{mech}\dot{M}\dot{}ₜ(T₃ᵣ−T₂ᵣ)

Applying another simplifying assumption that \dot{M}_{c}=\dot{M}ₜ, this leads to

(T₁ᵣ−T₀ᵣ)=η_{mech}(T₃ᵣ−T₂ᵣ)

Rearranging the above provides the relationship:

$${T}_{3 r} - {T}_{2 r} = \frac{{T}_{1 r} - {T}_{0 r}}{{η}_{mech}}$$

$$and$$

$${T}_{2 r} = {T}_{3 r} - \frac{{T}_{1 r} - {T}_{0 r}}{{η}_{mech}}$$

Thus, the logic 195 may be used to estimate a temperature differential (T₃r-T₂r) based on the pre-engine temperature, T₁, measured using pre-engine temperature sensor 150 disposed between the compressor 115 and the engine 105, and the initial temperature, T₀, measured using the initial temperature sensor 140 disposed at the input of the compressor 115. The temperature differential may be used to determine performance of the turbine 120, the engine 105, and/or the compressor 115. The temperature differential may further be used to indicate that the system 100 is operating inside or outside of the allowable parameters of the emissions control system.

Further, the logic 195 may be used to estimate the pre-turbine temperature, T₂, between the turbine 120 and the engine 105 based on the post-turbine exhaust temperature, T₃, measured using the post-turbine temperature sensor 185 disposed at the turbine outlet 180 of the turbine 120, the pre-engine temperature, T₁, measured using pre-engine temperature sensor 150 disposed between the compressor 115 and the engine 105, and the initial temperature, T₀, measured using the initial temperature sensor 140 disposed at the input of the compressor 115.

In a similar manner, the above equations can be used to express the pre-turbine exhaust temperature, T₂r, in terms of P₀r, P₀r, T₃r, and η_{mech}. It will be appreciated that the pre-engine pressure, P₁, can be measured directly using pre-engine pressure sensor 155 disposed between the compressor 115 and the engine 105 or determined based on the pre-engine temperature, T₁, according to the above equations. Similarly, the initial pressure P₀ can be measured using the initial pressure sensor 145 disposed at the input of the compressor 115 or determined based on the initial temperature T₀. Thus, the logic 195 may be used to estimate the pre-turbine exhaust temperature, T₂, between the turbine 120 and the engine 105 based on the post-turbine exhaust temperature, T₃, the pre-engine pressure, P₁, and the initial pressure, P₀.

While the turbocharger 110 illustrated in FIG. 1 depicts a singles stage compressor 115 and a single stage turbine 120, it will be appreciated that the compressor 115 may include multiple stages arranged in parallel or series. Similarly, the turbine 120 may include multiple stages arranged in parallel or series.

In some embodiments, the measured T₂ can be compared to the estimated T₂ to characterize the condition of the turbine 120. Similarly, the measured T₂ can be compared to the estimated T₂ to characterize the condition of the turbine 120. Likewise, the measured T₀ can be compared to the estimated T₀ to characterize the condition of the compressor 115. Similarly, the measured T₁ can be compared to the estimated T₁ to characterize the condition of the compressor 115. An RPM of the turbocharger 110 and/or a torque on a shaft coupling the turbine 120 to the compressor 115 may be used to distinguish between the condition of the turbine 120 and the compressor 115. As discussed above, P₀, P₁, P₂, and P₃ can be estimated. Thus, the estimated P₀ or P₁ can be compared to the respective measured P₀ or P₁ to characterize the condition of the compressor 115. Similarly, the estimated P₂ or P₃ can be compared to the respective measured P₂ or P₃ to characterize the condition of the turbine 120.

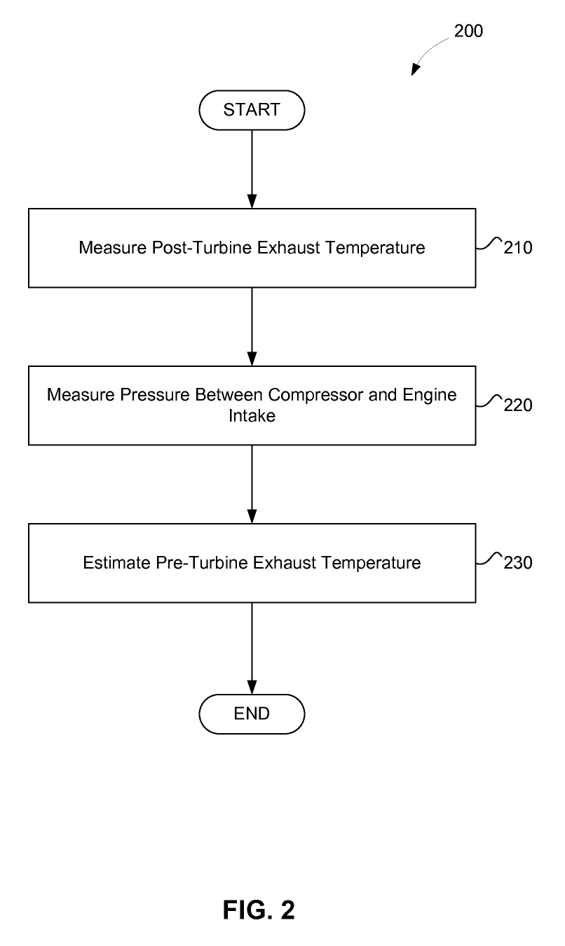

FIG. 2 illustrates an exemplary method 200 for estimating pre-turbine exhaust temperature. The method 200 comprises a step 210 of measuring a post-turbine exhaust temperature, T₃, at the turbine outlet 180 of the turbine 120 of the turbocharger 110, a step 220 of measuring a first pressure, P₁, between the engine intake 135 and the compressor 115 of the turbocharger 110, and a step 230 of estimating the pre-turbine exhaust temperature based upon the post-turbine exhaust temperature and the first pressure. As used herein, a measurement made “at” a location that is indicated by a structural component, such as at the turbine outlet 180, means that the measurement is made within a duct, tube, manifold, conduit, or the like close enough to the structural component as to be a reasonably representative measurement of a property of the air or the exhaust as it enters or exits the structural component.

Step 210 of measuring the post-turbine exhaust temperature and step 220 of measuring the first pressure between the engine intake 135 and the compressor 115 can be performed, for example, by post-turbine temperature sensor 185 and pre-engine pressure sensor 155, respectively, as controlled by logic 195. The logic 195, in these steps, can record instantaneous readings or time-averaged readings. The logic 195 can record the respective readings in a memory device such as random access memory (RAM). Although FIG. 2 shows steps 210, 220, and 230 being performed in a specific sequence, it will be understood that steps 210 and 220 can be performed simultaneously. Additionally, in continuous operation all three steps can be performed at the same time.

In step 230 the pre-turbine exhaust temperature, T₂, is estimated, for example, by logic 195. One way in which to make the pre-turbine exhaust estimate is to first solve for the ideal pre-engine temperature, T₁i, at the compressor output 130, then solve for the real pre-engine temperature, T₁r, at the compressor output 130, and then to solve for the pre-turbine exhaust temperature, T₂. Solving for the ideal pre-engine temperature can be achieved, for instance, by employing the measured first pressure, P₁, from step 220 together with default values for γ for air and the initial temperature and pressure (T₀i, P₀i) of the incoming air at the compressor intake 125 in the equation above that relates ideal temperatures to ideal pressures across the compressor 115. In various embodiments these default values are stored in a memory device of logic 195, but in other embodiments these defaults can be supplied to the logic 195 by a user through a user interface device (not shown) such as a graphical user interface (GUI). Alternatively, the method 200 can additionally comprise a step of measuring the initial temperature and/or pressure and in these embodiments solving for the ideal pre-engine temperature uses these measurements in place of default values.

Solving for the real pre-engine temperature, T₁r, can comprise utilizing the equation above that relates the real temperature difference across the compressor 115 to the ideal temperature difference. The equation can be solved using the determined value for the ideal temperature, T₁i, the initial temperature value used in the prior determination, and a default value for the efficiency of the compressor 115, e.g., stored in a memory device of logic 195. In some embodiments, rather than using a default value for the efficiency of the compressor 115, the compressor efficiency is determined according to operating conditions of the turbocharger 110 from data stored in a memory device of logic 195.

Solving for the pre-turbine exhaust temperature, T₂, can them be achieved using one of the equations above that relate the four real temperatures (T₀r, T₁r, T₂r, T₃r) given the determined value for the real pre-engine temperature, the measured post-turbine temperature from step 210, and the initial temperature value used in the prior determinations. As previously noted, the mass flow rates for the compressor 115 and the turbine 120 can be assumed to be equal or can assumed to be related by a proportionality constant. In further embodiments the proportionality constant can be a function of the operating conditions of the engine 105. Similarly, the mechanical efficiency of the turbocharger 110 in these equations can be a default value or can be determined from stored data based on operating conditions.

Additional methods of the invention pertain to uses for the estimated pre-turbine temperature. In the example of FIG. 1, the logic 195 is connected to the engine 105. Here, the logic 195 can be receiving information from the engine 105 such as RPM and/or controlling aspects of the operation of the engine 105 in a feedback loop based on the estimated pre-turbine temperature. Accordingly, a method of regulating the engine 105 can comprise the method 200 and the further step of altering an aspect of the operation of the engine in real time such as adjusting the air/fuel ratio or adjusting the engine timing based on the estimated pre-turbine temperature.

As noted previously, the estimated pre-turbine temperature can also be compared to a measured pre-turbine temperature. The measurement can be achieved, for example, with pre-turbine temperature sensor 170. These embodiments further comprise a step of measuring the pre-turbine temperature, T₂r, and a step of determining a difference between the measured pre-turbine temperature and the estimated pre-turbine temperature.

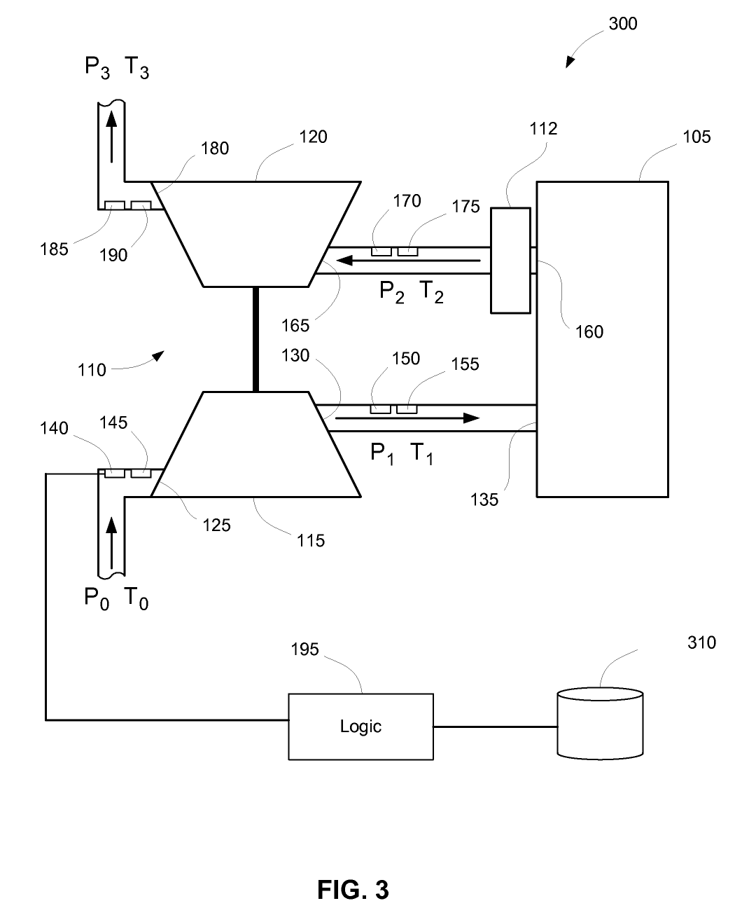

FIG. 3 illustrates a system 300 according to another exemplary embodiment of the present invention. The system 300 includes the same engine 105, turbocharger 110, array of sensors, and logic 195 as in FIG. 1. Here, the logic 195 represents a component of a testing system used for the verification of emission control systems. The logic 195 is configured to measure the post-turbine exhaust temperature, measure the air pressure between the engine intake 135 and the compressor 115, and configured to estimate the pre-turbine exhaust temperature. The logic 195 is further configured to record the measurements and the estimates in a database 310. The measurements and estimates can be recorded continuously, or at periodic intervals, in various embodiments. The database 310 can be directly connected to the logic 195, connected over a local area network (LAN), or connected over a Wide Area Network (WAN) such as the Internet. Records stored in the database 310 can be used in the verification process.

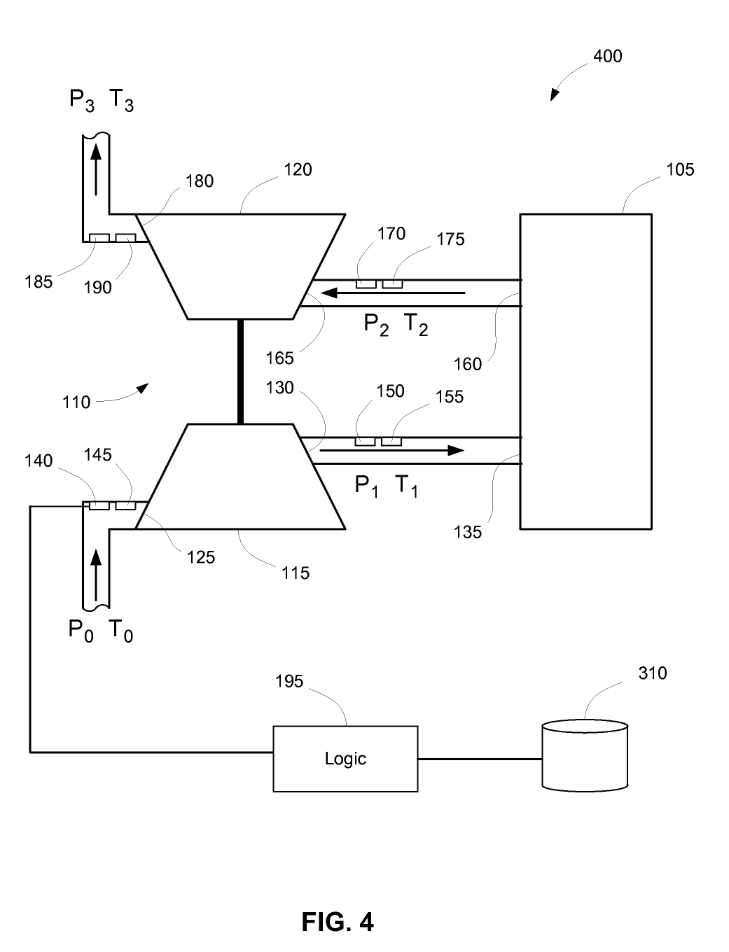

FIG. 4 illustrates a system 400 according to another exemplary embodiment of the present invention. FIG. 4 differs from FIG. 3 in that the system 400 does not include the emissions control system 112. The logic 195 in the system 400 is used for the characterization of the engine 105 without an emission control system. The logic 195 in system 400 is configured to estimate the pre-turbine exhaust temperature in the same manner as in the system 300 except that the estimate of the pre-turbine exhaust temperature is performed the without an emissions control system present in the system 400.

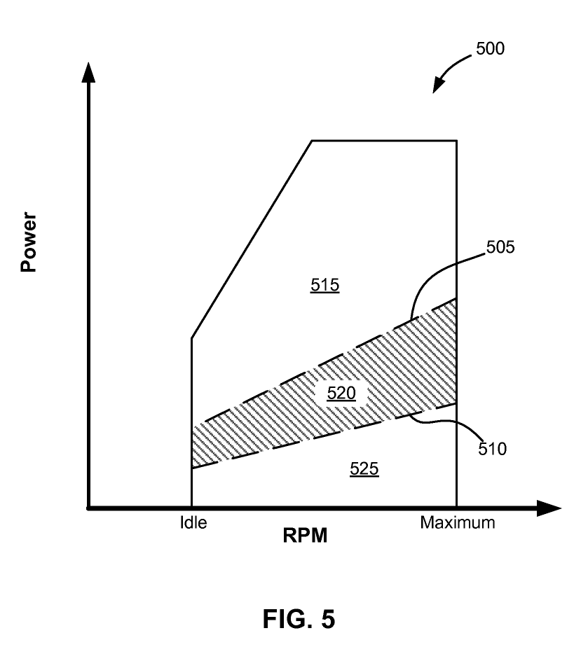

FIG. 5 is a diagram illustrating an engine operating envelope 500 for the engine 105. The vertical axis represents power output from the engine 105 while the horizontal axis represents rotations per minute (RPM) of the engine 105. The region inside the envelope 500 illustrates a range of power and RPM available for operation of the engine 105. Line 505 illustrates a minimum power for operation of the engine 105 within the emissions control limits when the estimated pre-turbine exhaust temperature (T₂) and exhaust pressure (P₂) are not known. Line 510 illustrates a minimum power for operation of the engine within the emissions control limits when either the estimated (T₂) or exhaust pressure (P₂) is known.

Region 515 illustrates a portion of the operating envelope 500 that is available for operation of the engine 105 without using the estimated T₂. Region 520 illustrates an additional portion of the operating envelope 500 that is available for operation of the engine 105 when the estimated T₂ or P₂ is known. Region 525 illustrates a portion of the operating envelope 500 where operation of the engine results in excessive emissions, damage to the engine 105, damage to the turbocharger 110, and/or damage to the emissions control system.

The estimated pre-turbine exhaust temperature and/or pressure may be used to extend the engine operating envelope for an emissions system. In qualifying an emissions control system on the engine 105 without using the estimated pre-turbine exhaust temperature and pressure the engine 105 may be limited to operation within region 515. However, using the estimated T₂ and/or P₂ the engine operation envelope for the emissions control system may be extended to include the region 520 for operations within emissions limits. Thus, region 515 illustrates the engine operating envelope qualified for the emissions system without using the estimated T₂ and P₂. Region 520 illustrates an extension of the engine operating envelope qualified for the emissions system using the estimated T₂ and/or P₂.

In operation, the combined regions 515 and 520 are available for operation of the engine 105 when the estimated T₂ and/or P₂ is known. The engine 105 may function within the region 520 without exceeding emissions control limits. However, without the estimated T₂ and P₂ the logic 195 may not be able to determine if the engine is being operated in region 520 or in region 525. The logic 195 may estimate T₂ and/or P₂. The logic 195 may further use the estimated T₂ and/or P₂ determine if the engine 105 is operating within region 520 (i.e., within emissions limits) or within region 525 (i.e., outside the emissions limits). This determination may be performed in real time and used to indicate the status of the operation. The logic 195 may use the real time estimate of T₂ and/or P₂ to adjust the engine for maintaining operations of the engine 105 within the combined region 515 and 520. Further, the estimated T₂ and/or P₂ may be recorded along with other engine performance parameters for analysis and evaluation.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for testing an emissions control system on an engine, the method comprising:
measuring a post-turbine exhaust temperature at an outlet port of a turbine of a turbocharger;
measuring a first air pressure between an engine intake and a compressor of the turbocharger; and
estimating a pre-turbine exhaust temperature using a microprocessor based upon the post-turbine exhaust temperature and the first air pressure.

2. The method of claim 1 further comprising measuring an initial air temperature at an intake of the compressor, wherein estimating the pre-turbine exhaust temperature is further based on the initial air temperature.

3. The method of claim 1 further comprising measuring an initial air pressure at an intake of the compressor, wherein estimating the pre-turbine exhaust temperature is further based on the initial air pressure.

4. The method of claim 1 further comprising altering an aspect of the operation of the engine based on the estimated pre-turbine temperature.

5. The method of claim 1 further comprising measuring the pre-turbine temperature, and determining a difference between the measured pre-turbine temperature and the estimated pre-turbine temperature.

6. The method of claim 1 further comprising recording the estimated pre-turbine exhaust temperature.

7. The method of claim 6 wherein recording the estimated pre-turbine exhaust temperature comprises recording the estimated pre-turbine exhaust temperature at intervals over a period of time with and without the emission control system.

8. A system comprising:
an engine;
a turbocharger in fluid communication with the engine and including
a compressor having a compressor intake and a compressor output, and
a turbine having a turbine intake and a turbine output;
a turbine output temperature sensor disposed at the turbine output;
a pre-engine pressure sensor disposed between the compressor output and an engine intake of the engine and configured to measure a first pressure; and
logic in communication with the turbine output temperature sensor and the pre-engine pressure sensor, and configured to estimate a pre-turbine exhaust temperature based upon the post-turbine exhaust temperature and the first pressure.

9. The system of claim 8 further comprising a vehicle, wherein the engine is configured to propel the vehicle.

10. The system of claim 8 further comprising an electric generator, wherein the engine is configured to generate electricity.

11. The system of claim 8 wherein the engine comprises a diesel engine.

12. The system of claim 8 further comprising an initial temperature sensor disposed at the compressor intake.

13. The system of claim 8 further comprising an initial pressure sensor disposed at the compressor intake.

14. The system of claim 8 further comprising a pre-turbine temperature sensor disposed between the turbine intake and an exhaust port of the engine.

15. The system of claim 8 wherein the logic is further configured to alter an aspect of the operation of the engine based on the estimated pre-turbine exhaust temperature.

16. A method for extending an operating envelope of an engine in fluid communication with an emissions control system and a turbocharger including a compressor and a turbine, the method comprising:
receiving at a computing system a first value representing an initial temperature from an initial temperature sensor disposed upstream of an intake of the compressor;
receiving at the computing system a second value representing a compressor temperature from a pre-engine temperature sensor disposed between the compressor and the engine;
receiving at the computing system a third value representing a post-turbine exhaust temperature from a post-turbine sensor disposed downstream of an outlet of the turbine;
estimating a pre-turbine exhaust temperature of exhaust gas between the engine and the turbine based upon the first value, the second value and the third value using the computing system;
determining if the engine is operating within the operating envelope for the engine and the emissions control system based on the estimated pre-turbine exhaust temperature; and
activating an indicator based on the determination.

17. The method of claim 16 further comprising altering an aspect of the operation of the engine based on the estimated pre-turbine exhaust temperature to operate the engine within the operating envelope.

18. The method of claim 16 further comprising recording the estimated pre-turbine exhaust temperature at intervals over a period of time.

19. The method of claim 18 wherein at least one of the intervals is about one minute, two minutes, four minutes, eight minutes, fifteen minutes, thirty minutes, one hour, two hours, four hours, eight hours, twelve hours, one day, two days, one week, or one month.

20. The method of claim 18 wherein the period of time is about one hour, two hours, four hours, eight hours, twelve hours, one day, two days, one week, one month, one year, or two years.

21. The method of claim 16 wherein receiving the first value, the second value, and the third value and estimating the pre-turbine exhaust temperature is performed in real time.
